(19) United States
(12) Patent Application Publication
(10) Pub. No.: US 2013/0035904 A1
(43) Pub. Date: Feb. 7, 2013

(54) 3D PLANT MODELING SYSTEMS AND METHODS

(71) Applicant: Daniel Kuhn, Stilwell, KS (US)

(72) Inventor: Daniel Kuhn, Stilwell, KS (US)

(21) Appl. No.: 13/522,460

(22) PCT Filed: Jan. 14, 2010
(86) PCT No.: PCT/US10/20981

§ 371 Date: Oct. 12, 2012

(51) Int. Cl. G06F 17/50

(52) U.S. Cl. 703/1

(57) ABSTRACT

Systems and methods for leveraging a preliminary plant model to create a detailed physical plant model are presented. The system stores instances of component primitives, and can utilize stored geometries of the component primitives to identify a plurality of physical components to form a physical plant model. The physical plant model can realize at least a portion of the component runs based on equations and mapping definitions that establish relationships among the geometries of the equipment and piping. The components of the physical plant model can be mapped to catalog items based on the geometries of the components. After translation, a bill of materials listing the physical plant model components can be produced.

### FIELD OF THE INVENTION

The field of the invention is software translation utilities.

### BACKGROUND OF THE INVENTION

When building a processing plant, extensive engineering development work is typically performed during the plant's front end engineering and design phase. This work often includes developing a plot layout of the facilities and may include development of three dimensional (“3D”) computer models of one or more processing units showing preliminary equipment, piping, and structures. These preliminary models represent the starting point for detailed engineering models.

Current rapid plant modeling software programs lack the ability to translate the equipment and piping components from these preliminary models into detailed engineering models which more precisely represent an actual physical plant. As a result, the entire preliminary model generally is recreated using software programs capable of producing more detailed designs. This can be problematic, especially in complex plant models having multiple process units, because of the significant amount of time needed to recreate detailed versions of the preliminary models.

Consequently, although some configurations and methods for rapidly designing preliminary 3D models for process plants are known in the art, all or almost all of them suffer from one or more disadvantages. Thus, there is still a need to provide systems and methods for model translation utilities, especially systems and methods that can leverage data from an existing preliminary model to automatically create a more detailed physical model.

### SUMMARY OF THE INVENTION

The present invention is directed to processing unit modeling systems and methods that include a primitives database storing geometries of components such as equipment and piping used in a preliminary modeling environment, and a components database storing characteristics/descriptions/attributes of real, physical components. The stored geometries of the primitives can include a start point, an end point, and a center point. One or more orientation vectors of each instance of the primitives can also be stored. By providing the start, end, and center points of each instance of the component primitives as well as one or more orientation vectors, precise positions and orientations of the primitives can be determined. It is also contemplated that additional parameters for each primitive can be stored including, for example, width, height, thickness, starting diameter, and ending diameter.

Preferred systems can have a modeling engine configured to establish model component runs using the component primitives to create at least a portion of a preliminary plant model. The model component runs can have a plurality of component primitives of the same or different type linked together based on their geometries. Thus, for example, a model component run might include a cylinder primitive linked to an hourglass-shaped primitive linked to a cylinder primitive, which might illustrate two pipe segments coupled to a gate valve.

The system can also include a translation engine used to create a plurality of physical components from the model component runs to form at least a portion of a physical plant model. The physical plant model can realize at least part of the model component runs using mapping functions to map the piping, and equations to establish relationships among the geometries of the equipment primitives with the physical equipment. In preferred embodiments, the translation engine can utilize equations and mapping definitions to map the instances of the component primitives in the preliminary plant model to catalog items of physical components using the geometries of component primitives or their shapes. Due to the likely overlapping use of the geometric primitives to represent different components of the preliminary plant model, the equations can advantageously provide for a one-to-many mapping that allows for a primitive group to be mapped to multiple types of physical equipment based on the geometries of the primitives.

Particularly contemplated systems can include an exception generator that identifies the portions of the model component runs, if any, which lack substantially matching physical components. This is advantageous as it verifies that the preliminary model components can be used to construct the physical plant models, and thereby ensures that the physical plant models can actually be built and function as designed. For example, the exception generator can review the model component runs to see if they have matching physical counterparts based on the geometries of the component primitives in the model component runs and the physical components available.

Various objects, features, aspects and advantages of the present invention will become more apparent from the following detailed description of preferred embodiments of the invention.

### BRIEF DESCRIPTION OF THE DRAWING

FIG. 1 is a diagram of a possible embodiment of a processing unit modeling system.

FIG. 2 is a flowchart showing the steps of a method of translating a preliminary plant model.

FIGS. 3A-3B are front and back isometric views of one embodiment of a preliminary plant model.

FIG. 4 is an isometric view of one embodiment of a model component run composed of a plurality of piping and equipment primitives.

FIG. 5 is an isometric view of another embodiment of a model component run composed of a plurality of piping and equipment primitives.

FIGS. 6A-6B are front and back isometric views, respectively, of one embodiment of a physical plant model.

FIG. 7 is an isometric view of another embodiment of a portion of a physical plant model having a plurality of physical equipment and piping components.

FIG. 8 is an enlarged view of yet another embodiment of a portion of a physical plant model having physical equipment and piping components.

FIG. 9 is a diagram of another possible embodiment of a processing unit modeling system.

### DETAILED DESCRIPTION

Throughout the following discussion, numerous references will be made regarding engines, servers, services, interfaces, portals, platforms, or other systems formed from computing devices. It should be appreciated that the use of such terms is deemed to represent one or more computing devices having at least one processor configured to execute software instructions stored on a computer readable media. For example, a server can include one or more computers operating as a web server, database server, or other type of computer server in a manner to fulfill described roles, responsibilities, or functions.

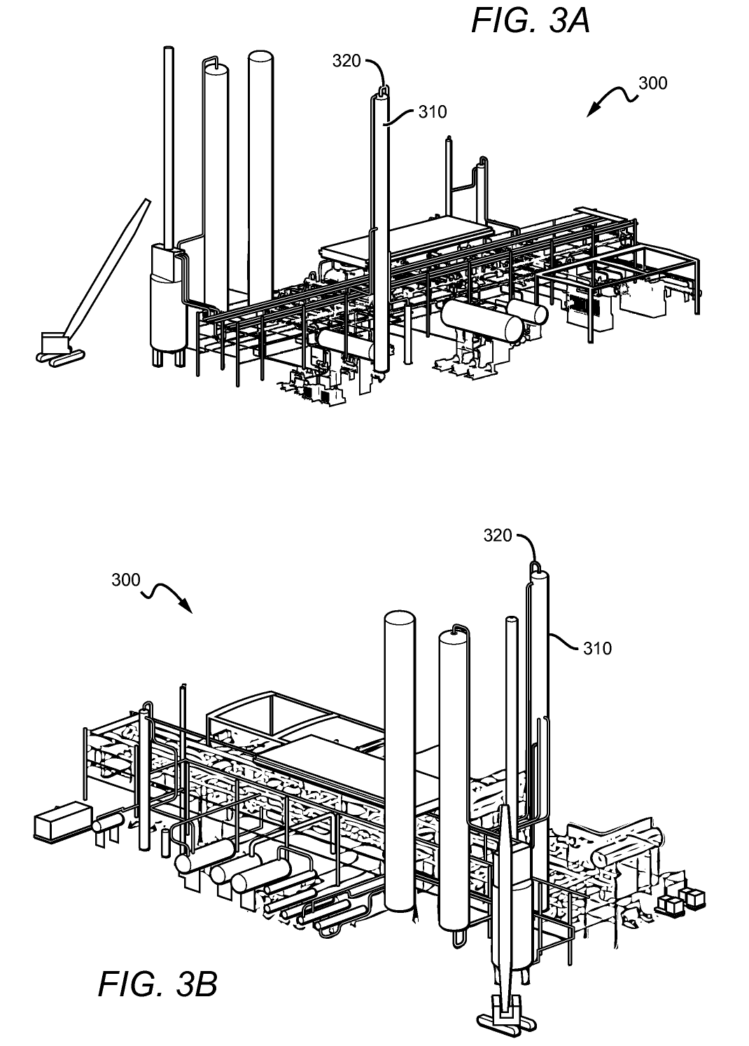

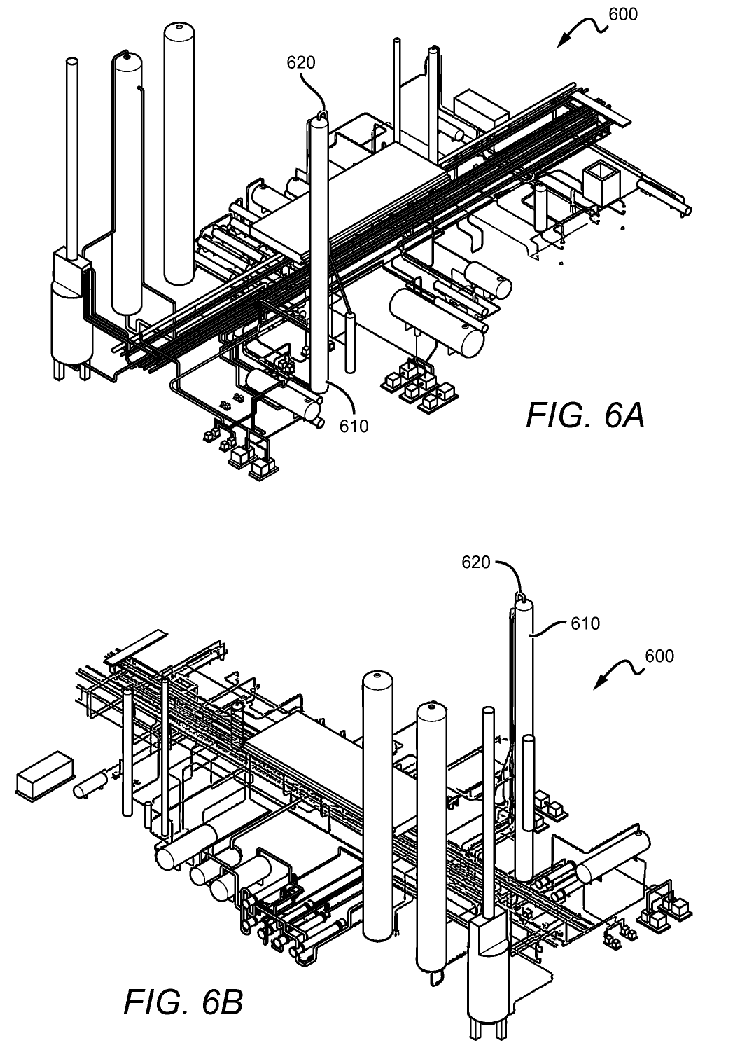

The present invention is directed to processing unit modeling systems and methods that can leverage preliminary plant models including, for example, those models shown in FIGS. 3A-3B. It should be appreciated that these modeling systems and methods increase the efficiency of creating detailed design models of the preliminary plant models, such as to those shown in FIGS. 6A-6B, which results in significant time savings. For example, rather than recreating multiple model component runs in a physical plant model, the configurations and methods discussed herein allow for the model component runs to be translated into a physical plant model while establishing relationships between the piping primitives and physical catalog items. In this manner, a detailed physical plant model can be created from which a bill of materials can be produced that lists the components of the physical plant model.

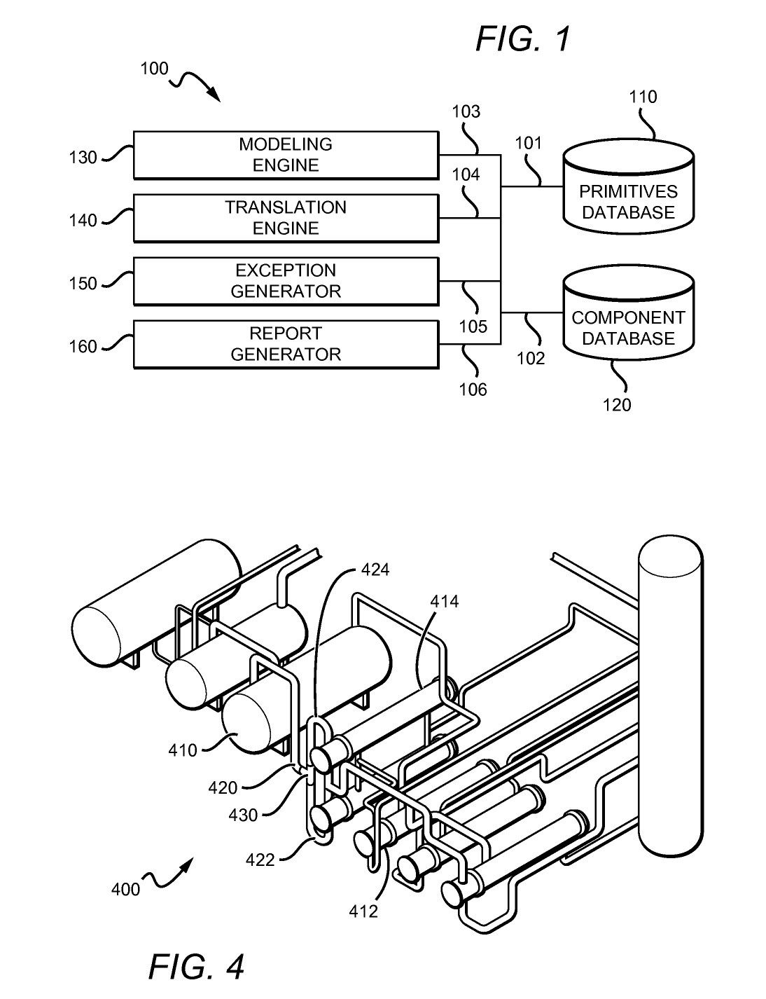

One exemplary configuration for a processing unit modeling system 100 is depicted in FIG. 1. System 100 can comprise a primitives database 110 and a components database 120.

The primitives database 110 can include a library of primitives having generic geometries along with the defined geometries of the instances of each primitive used for the components in the preliminary plant model. It is also contemplated that the instances of the component primitives can be stored in a separate file, database, or other storage scheme. The generic geometries represent parameters of a component primitive, in which the parameters do not necessarily have a set value. For example, the geometries could include a start point parameter that has a NULL or un-set value for the parameter. During the modeling process, instances of the primitives used in the preliminary plant models can have their geometric parameters assigned values that correspond to the instance of that primitive in the preliminary plant model. For example, a start point for a pipe primitive might be a three dimensional coordinate relative to a plant origin. The components database 120 can store characteristics/descriptions/attributes of physical equipment.

The library of primitives can be used to represent equipment, piping and other components in the preliminary plant model including, for example, weld-o-lets, Y-shaped branches, T-shaped branches, stub-ins, flanges, valves, manifolds, nozzles, and other in-line components. Some components could be represented by two or more primitives. The stored geometries can include start points, end points, center points, orientation vectors, radii, diameters, thicknesses, heights, widths, and other geometric references. For example, by plotting the start, end, and center points of a cylinder primitive, the precise position of a straight pipe segment can be determined.

Connections 101-106 can include network connections, possibly the Internet, or other packet switched network. In addition, all commercially-suitable wired or wireless connections are contemplated.

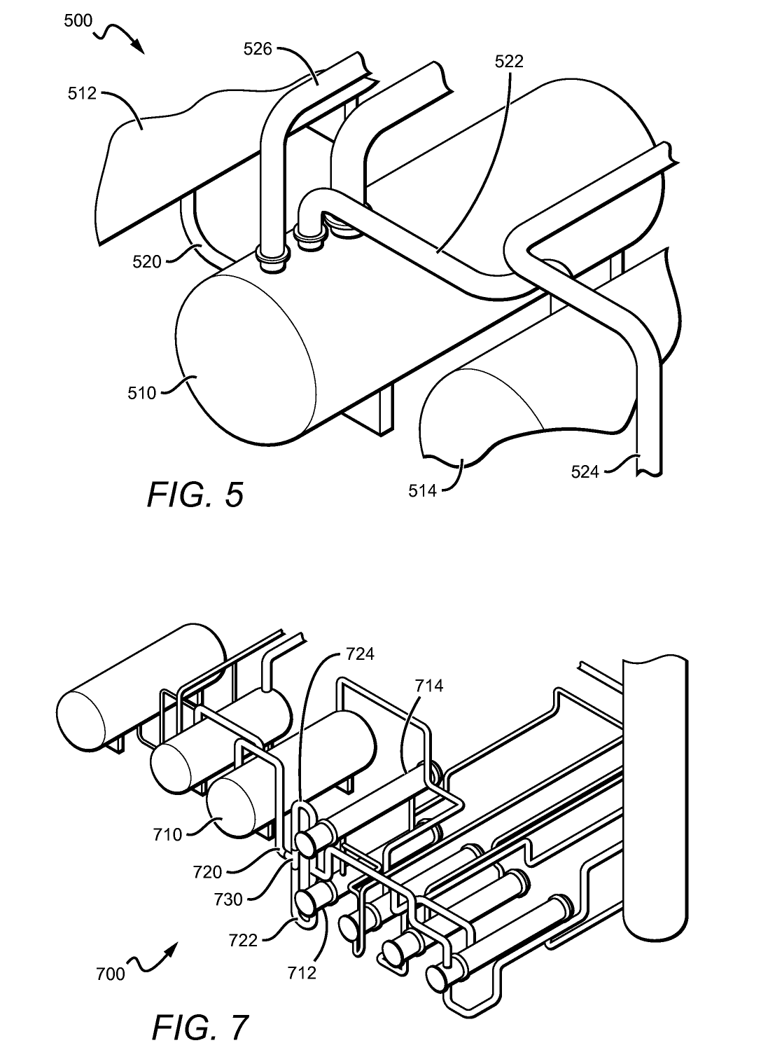

Modeling engine 130 can access primitives database 110 and components database 120 via connections 101 and 103. Using the component primitives stored in the primitives database 110, the modeling engine 130 can thereby establish model component runs such as those shown in FIGS. 4-5 that utilize multiple instances of the component primitives linked together based on their geometries.

System 100 can further include a translation engine 140 that can access the primitives database 110 and components database 120 via connections 101-102 and 104. The translation engine 140 can be configured to create a physical plant model such as that shown in FIGS. 7-8, and that has a plurality of physical components from the components database 120. The physical plant model is created using equations establishing relationships among the geometries of the equipment primitives with the physical equipment, and using a mapping mechanism to establish relationships between piping primitives and physical piping catalog components. In this manner, the translation engine 140 can therefore realize at least a portion of the model component runs of the preliminary plant model. It is especially preferred that the translation engine 140 be configured to receive a serialized description of the model component runs as an input. The serialized description such as XML could be an output of the modeling engine 130, or be an output of a separate engine based upon the output of the modeling engine 130.

The equations can be stored in a mapping file, database, or other storage scheme (not shown). Depending on the geometries of the equipment and the primitives used, the equipment can be mapped based upon (1) specific parameters, or (2) the designed shape of the primitive. The piping components can be translated using a one-to-one mapping for component type and by mapping the line classes of the piping, which allows the piping components to be matched to their correct physical counterparts.

In some contemplated embodiments, the equations used by the translation engine 140 can map the geometries of the equipment primitives in the primitives database 110 to either equipment primitives or to parametric equipment symbols in the detailed physical plant model. Preferably, the equations can provide for a one-to-many mapping, such that a single group of equipment primitives can be mapped to multiple types of physical equipment items based upon the specific geometry of each instance of the equipment primitive.

In other contemplated embodiments, the translation code or mapping scheme used by the translation engine 140 can map geometries of the piping primitives in the primitives database 110 to catalog items of the physical components stored in the components database 120. Thus, for example, the translation engine could utilize the geometries of each piping primitive in the model component runs to create a relationship between each primitive and a catalog item. For example, depending on the length, thickness and radii of a cylinder primitive, the primitive could map to a certain pipe component in the catalog. But a cylinder primitive having a different radius might map to a different pipe component in the catalog.

In a preferred configuration, the system 100 can have an exception generator 150 that can be configured to identify component primitives in the model component runs that lack substantially matching physical counterparts in the components database 120. This is advantageous as such component primitives could not be constructed in an actual physical plant based upon the physical plant model. The exception generator can include an editor interface with which a user can exclude a primitive from being translated. Thus, for example, should the exception generator determine that an instance of a primitive representing a pipe segment has a null value, a near zero-length value such as 0.1 mm, or other impractical value, or that a reducer has the same diameter at each end, a user could access the editor interface to exclude that instance of the primitive from the model component run. In this manner, the remainder of the model component run could then be properly mapped to physical components. The exception generator 150 can also be configured to automatically exclude components with errors, or create a report of the errors for later review by a user. After an error is discovered, the translation engine 140 can be used to change the mapping of the piping or equipment primitive in a model component run, and thereby control which physical parts will be associated with the primitive.

In further contemplated aspects, system 100 can include a report generator 160. The report generator 160 preferably uses the physical plant model produced by the translation engine 140 and the associated catalog items of physical equipment to create a material take off list. The material take off list could include, for example, the catalog items to be used to build the physical plant model, as well as each of the item's cost, SKU or other reference number, manufacturer, and the specific dimensions of each item. The material take off list can be used to establish work orders, determine lead times, place orders, interface with manufacturers, and so forth. Thus, for example, a physical conduit component such as a pipe segment can be associated with a specific real world catalog item. In this manner, the report generator can determine the actual items needed to construct the plant, as well as the total cost of the materials.

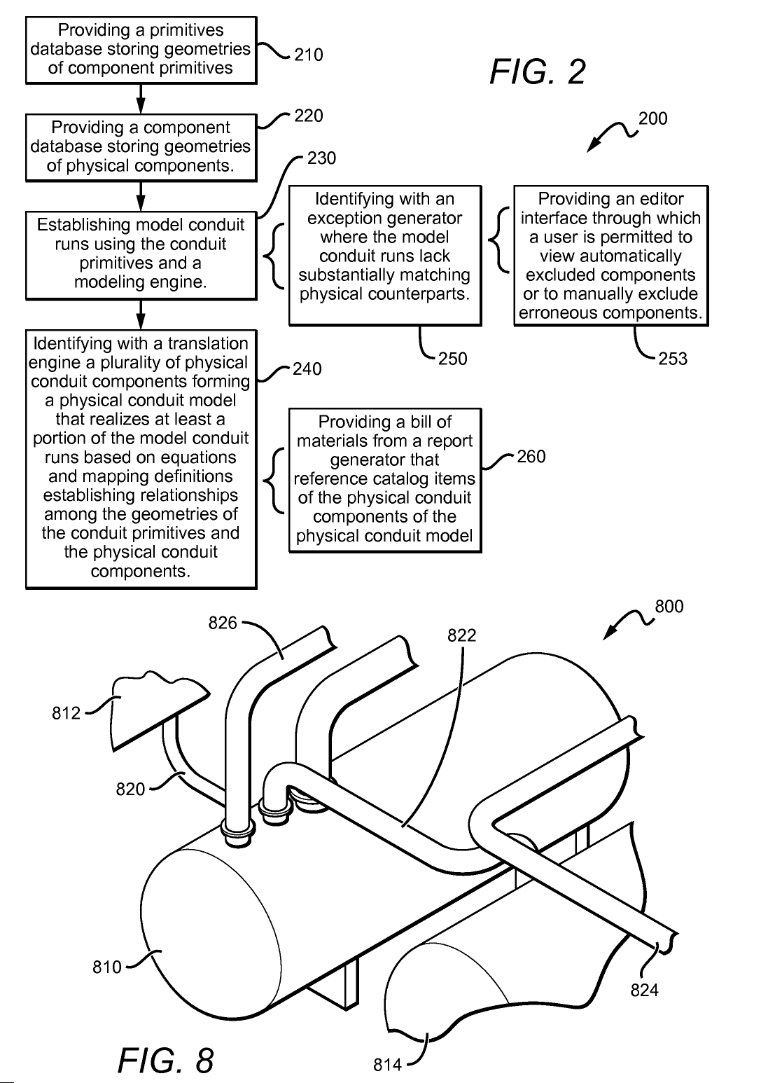

FIG. 2 presents a possible method 200 of translating preliminary plant models. Method 200 can include step 210 in which a primitives database is provided that can store a library of primitives with their associated geometries. Suitable databases can include, for example, Access, PostgreSQL, MySQL, or other databases. It is also contemplated that the primitives database could be based on an object-based schema where the primitives have one or more attributes or properties. Properties can comprise parameter-value pairs, and example properties can include, for example, start-points, end-points, origins, vectors, and so forth. Instances of the primitives used in the model component runs can be stored in the primitives database or a separate database, file, or other data storage schemes.

Step 220 can include providing a components database storing physical components and their associated information (e.g., size, shape, catalog number, etc.). It is contemplated that the primitives database and the components database can be the same database or distinct databases.

Step 230 can include establishing a model component run using a modeling engine. The modeling engine can link together component primitives based on their geometries. An exemplary modeling engine is Bentley PlantWise™

In step 240, a physical component model can be created from the preliminary model component runs using a translation engine. The translation engine can use equations and mapping definitions, which can be stored in files, databases, or other storage schemes. The physical component model can be formed from a serialized description of the model component runs as input to the translation engine. However, any commercially suitable format(s) describing the model component runs can also be used. The resulting physical component model preferably can realize at least a portion of the model component runs based on equations and mapping definitions establishing relationships among the geometries of the component primitives and the physical components. It is particularly preferred that the equations provide for a one-to-many mapping from geometry of a group of equipment primitives to multiple physical equipment types. The equipment primitives can thereby be mapped to a variety of actual physical equipment types.

To help ensure that an actual physical plant can be constructed from the physical plant model, optional step 250 includes identifying with an exception generator where the model component runs lack substantially matching physical counterparts. Once identified, any problems can be automatically excluded from the physical plant model, or be manually excluded using an editor interface 253, for example. Once the physical plant model is created, a material take off list can be provided in step 260 using a report generator that references catalog items of the physical components of the physical plant model.

In FIGS. 3A-3B, an embodiment of a preliminary plant model 300 is shown having a plurality of equipment primitives 310 and piping primitives 320. In FIG. 4, a portion of a preliminary plant model 400 is shown. The preliminary plant model includes a model component run comprising equipment primitives 410, 412, and 414, which are coupled together by piping primitives 420, 422, and 424. A “T” junction 430 is also shown which allows piping primitive 420 to be coupled by piping primitives 422 and 424 to equipment primitives 412 and 414, respectively.

In FIG. 5, an enlarged portion of a preliminary plant model 500 is shown, in which a model component run includes equipment primitives 510 and 514 coupled together by piping primitive 522. The preliminary plant model also includes equipment primitive 512 and piping primitives 524 and 526, which compose various other model component runs.

FIGS. 6A-6B illustrate a physical plant model 600 at least partially created from the preliminary plant model shown in FIGS. 3A-3B using a translation engine. The physical plant model 600 has a plurality of physical equipment 610 and piping components 620.

In FIG. 7, a portion of a physical plant model 700 is shown, which realizes at least a portion of the preliminary plant model shown in FIG. 4. With respect to the remaining numerals in FIG. 7, the same considerations for like components with like numerals of FIG. 4 apply. In FIG. 8, an enlarged portion of a physical plant model 800 is shown, which realizes at least a portion of the preliminary plant model shown in FIG. 5. With respect to the remaining numerals in FIG. 8, the same considerations for like components with like numerals of FIG. 5 apply.

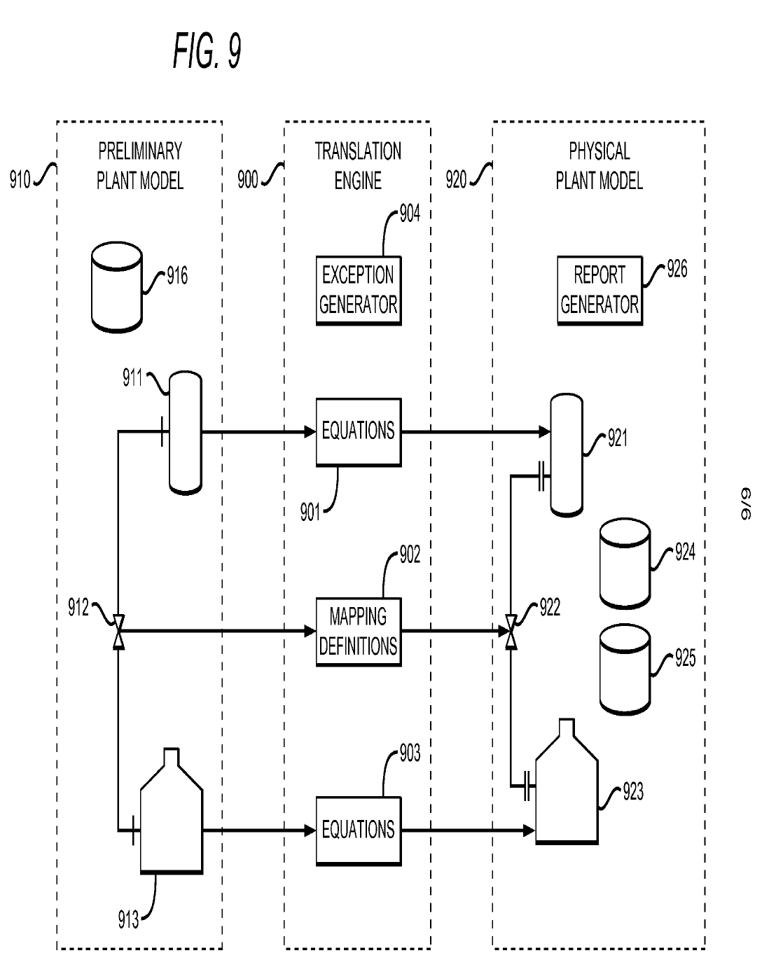

As shown in FIG. 9, a translation engine 900 can be used to establish relationships among the geometries of the component primitives 911-913 in the preliminary plant model 910, and the physical components 921-923 of physical plant model 920. The preliminary plant model 910 can have a plurality of component primitives, which are stored in database 916.

Different equations and mapping definitions can be used to map the various components of the preliminary plant model 910 to physical components stored in component database 924 and physical parts stored in catalog of parts 925. For example, primitives representing equipment such as component primitive 911 can be mapped using mapping equations 901 to create physical parametric equipment component 921 based on the parameters of the component primitive 911. In the preliminary plant model, the component primitive 911 might be represented as a vertical vessel with multiple transitions. Mapping definitions might be used to determine that this primitives group would map to a parametric complex vertical cylindrical equipment type. Mapping equations 901 might also define how to determine parameter values for physical equipment component 921. An exemplary equation, “−([SECT2:geoloc.Z]−[SKIRT:geoloc.Z])”, might be used to determine the value of a parameter that defines the distance between the base of the equipment and an intermediate tangent line. The physical equipment component 921 might be represented as having a center point at the coordinates x=10.0 m, y=−12.25 m, and z=0 with respect to an origin point, and having a length of 19 m and an upper section diameter of 2 m. In a similar fashion, designed equipment such as component primitive 913 can be mapped by translation engine 900 using mapping equations 903 and the shapes of the component primitive 913 to create physical component 923.

For piping components such as component primitive 912, the translation engine 900 can use mapping definitions 902 along with the type of component and line class of the component primitive 912 to create physical component 922. In the preliminary plant model, a component primitive might be represented as having a start point of x=20.0 m, y=12.0 m, and z=2.0 m; a center point of x=20.0 m, y=12.2286 m, and z=2.0 m; and an end point of x=20.0 m, y=12.4572 m, and z=2.0 m. The component primitive might also have a start and ending nominal diameter equal to 12.0 inches. Mapping definitions can be used to map the geometries, line classes, fluid codes, or other parameters of the piping primitive to corresponding parameters of a physical component. A resulting physical component 922 might be represented as an actual globe valve catalog component.

The translation engine 900 can also have an exception generator 904 such as that described above. It is also contemplated that the exception generator could be separate from the translation engine 900. Furthermore, a report generator 926 can be used to create a bill of materials based upon the relationships between the physical components of the physical plant model and items in the catalog of parts 925.

Thus, specific embodiments and applications of systems and methods for processing preliminary plant models have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A processing unit modeling system, comprising:
a primitives database storing geometries of component primitives;
a components database storing geometries of physical components;
a modeling engine configured to establish model component runs using the component primitives, where the model component runs comprise component primitives linked together based on their geometries; and
a translation engine configured to identify a plurality of physical components forming a physical plant model that realizes at least a portion of the model component runs based on equations and mapping definitions describing mapping relationships among the geometries of the component primitives and of the physical components.

2. The system of claim 1, further comprising an exception generator configured to identify where the model component runs lack substantially matching physical counterparts.

3. The system of claim 1, further comprising an editor interface through which a user is permitted to exclude at least a portion of the model component runs or view the component primitives that were automatically excluded.

4. The system of claim 1, further comprising a report generator configured to provide a material take off list referencing catalog items of the physical components of the physical plant model.

5. The system of claim 1, wherein the equations or mapping definitions comprise mappings of the geometries of component primitives to catalog items of the physical components.

6. The system of claim 5, wherein the geometries of the component primitives each include a start point, an end point, and a center point.

7. The system of claim 6, wherein the geometries of at least one of the component primitives further includes an orientation vector.

8. The system of claim 1, wherein the equations provide for a one-to-many mapping from geometry of an equipment primitive to multiple physical equipment component types.

9. The system of claim 1, wherein the translation engine is further configured to receive a serialized description of the model component runs as input.

10. A method of translating a preliminary plant model, comprising:
providing a primitives database storing geometries of component primitives;
providing a components database storing geometries of physical equipment;
establishing model component runs using the component primitives and a modeling engine, where the model component runs comprise component primitives linked together based on their geometries; and
identifying with a translation engine a plurality of physical components forming a physical plant model that realizes at least a portion of the model component runs based on equations and mapping definitions establishing relationships among the geometries of the component primitives and the physical components.

11. The method of claim 10, further comprising identifying with an exception generator where the model component runs lack substantially matching physical counterparts.

12. The method of claim 11, further comprising providing an editor interface through which a user is permitted to view automatically excluded primitive components or manually exclude a portion of the model components runs.

13. The method of claim 10, further comprising creating a material take off list from a report generator that references catalog items of the physical components of the physical plant model.

14. The method of claim 10, wherein the equations and mapping definitions comprise mappings of the geometries of component primitives to catalog items of the physical components.

15. The method of claim 14, further comprising storing a start point, an end point, and a center point of the component primitives in a preliminary model file.

16. The method of claim 15, further comprising storing an orientation vector of the component primitives in the preliminary model file.

17. The method of claim 10, wherein the equations provide for a one-to-many mapping from geometry of an equipment primitive to multiple physical equipment components.

18. The method of claim 10, wherein the translation engine is further configured to receive a serialized description of the model component runs as input.
